(19) United States
(12) Patent Application Publication
(10) Pub. No.: US 2005/0123760 A1
(43) Pub. Date: Jun. 9, 2005

(54) Light-emitting nanoparticle compositions

(76) Inventors: J. Kevin Cammack, Palo Alto, CA (US); Ghassan E. Jabbour, Tucson, AZ (US); Sheng Li, Vista, CA (US); Jesse Froehlich, Vista, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/961,423

(22) Filed: Oct. 7, 2004

Related U.S. Application Data
(60) Provisional application No. 60/511,520, filed on Oct. 15, 2003.

(51) Int. Cl. C09K 11/06; C09K 11/02; H05B 33/14; B32B 1/00

(52) U.S. Cl. 428/403; 428/690; 428/917; 252/301.16; 313/504; 257/40

(57) ABSTRACT

Light-emitting chromophores (lumophores) that emit different colored light may be covalently attached to a nanoparticle core such as a silsequioxane. The light emission profile of the resulting lumophore-functionalized nanoparticle is the sum of the light emission of all of the lumophores attached to the nanoparticle. In some embodiments, the lumophore-functionalized nanoparticle is white light-emitting.

### RELATED APPLICATION INFORMATION

This application claims priority to U.S. Provisional Patent Application No. 60/511,520, filed Oct. 15, 2003, which is hereby incorporated by reference in its entirety.

### BACKGROUND OF THE INVENTION

1. Field of the Invention

This invention relates to compositions capable of emitting light, and more particularly, to light-emitting compositions that comprise lumophore-functionalized nanoparticles.

2. Description of the Related Art

Organic electroluminescent devices capable of emitting white light are desirable because of their potential utility as backplane lights for displays, overhead lighting and other lightweight, low profile, low power lighting applications. White light-emitting Organic Light-Emitting Diode (OLED) devices with high color purity and brightness exceeding 2000 cd/m² have been demonstrated at least since 1994. (1, 2) However, there is considerable difficulty in preparing white emitting OLEDs because it is generally quite difficult to prepare single molecules that can emit white light. Several ineffective strategies have been employed to generate white light by electroluminescence including: preparation of devices with multiple emitting layers, e.g. red, green and blue (2); use of a single emitting layer doped with multiple emitters of different colors (1, 3, 4); blends of different color emitting polymers (5, 6); excimer (7) or “electromer” (8) emission from a semiconducting polymer; excimer emission from an interface (9); and broad emission from metal chelates (10).

There are significant drawbacks to all of these approaches. Preparation of devices with multiple emitting layers is typically more difficult and time consuming than preparation of devices with fewer layers. Device failure is more likely to occur due to interfacial defects, and matching the conduction band energies of multiple layers is complicated at best. Small molecules tend to have limited solubility in polymers. Blends of small molecule emitters and polymer dispersions of emitters tend to aggregate or phase separate, which often results in decreased device performance and poor color stability. Excimers and electromers often show field dependent emission spectra and their formation changes the transport properties of the device. Classical polymer-based systems are typically exceedingly difficult to purify and exhibit poor batch-to-batch reproducibility. It is also very difficult to control the structure of classical polymer-based systems except in a very general sense. Finally, broad spectral emission from small single molecules typically heavily consists of green wavelength components and has a much lower efficiency for the red and blue components. The human eye is most sensitive to green light, hence in an actual device it is desirable to have the red and blue wavelength components brighter than the green components. Molecular orbital and quantum mechanical theories forbid this type of emission from a single small molecule material.

The following articles are referred to above and incorporated by reference herein in their entireties:
1. Kido, J., Hongawa, K., Okuyama, K. & Nagai, K. White light-emitting organic electroluminescent devices using the poly(N-vinylcarbazole) emitter layer doped with three fluorescent chromophores. Applied Physics Letters 64, 815 (1994).
2. Kido, J., Kimura, M. & Nagai, K. Multilayer White light-Emitting Organic Electroluminescent Device. Science 267, 1332-1334 (1995).
3. Kido, J., Ikeda, W., Kimura, M. & Nagai, K. Jpn. J. Appl. Phys. (part 2) 35, L394 (1996).
4. Tasch, S. et al. Applied Physics Letters 71, 2883 (1997).
5. Yang, Y. & Pei, Q. Journal of Applied Physics 81, 3294 (1997).
6. Granstrom, M. & Inganas, O. Applied Physics Letters 68, 147 (1996).
7. Gao, Z. Q., Lee, C. S., Bello, I. & Lee, S. T. White light electroluminescence from a hole-transporting layer of mixed organic materials. Synthetic Metals 111-112, 39-42 (2000).
8. Lee, Y. -Z. et al. White light electroluminescence from soluble oxadiazole-containing phenylene vinylene ether-linkage copolymer. Applied Physics Letters 79, 308-310 (2001).
9. Chao, C. -I. & Chen, S. -A. White light emission from exciplex in a bilayer device with two blue light-emitting polymers. Applied Physics Letters 73, 426-428 (1998).
10. Hamada, Y. et al. White light-emitting material for organic electroluminescent devices. Jpn. J. Appl. Phys. (part 2) 35, L1339-L1341 (1996).

### SUMMARY OF THE INVENTION

We have discovered a method for producing efficient light-emitting molecules using a nanoparticle approach. In this method, lumophore(s) are attached to a nanoparticle core to form a lumophore-functionalized nanoparticle. Mixtures of lumophores, e.g., red and blue lumophores, may be used to generate various colors, including white light. In an embodiment, the nanoparticle core is a single silsequioxane. For example, the silsequioxane core represented by formula (I) below has a relatively stiff cubical structure and the lumophores, represented by R groups in formula (1), are attached at the vertices of the silsequioxane. This invention is not bound by any theory of operation, but it is believed that the nanoparticle core acts to decouple the emitting states of the lumophores and prevent physical interactions between chromophore moieties. White light is obtained by the appropriate choice of lumophores. In an embodiment, the chosen lumophores have Commission Internationale de L'Eclairage (CIE) color coordinates that lie on a line which intersects the achromatic point. The relative numbers of each chromophore are preferably selected so that the resulting lumophore-functionalized nanoparticle emits the desired color. Various colors may be emitted, depending on the relative numbers and identities of the lumophores. In an embodiment, the lumophores are selected to provide a white light-emitting lumophore-functionalized nanoparticle.

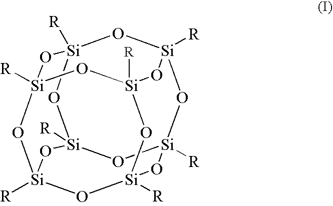

A preferred embodiment provides a light-emitting composition comprising a blue light-emitting chromophore and a red light-emitting chromophore covalently attached to a nanoparticle core. Preferably, the light-emitting composition comprises a silsequioxane group of the formula (II)

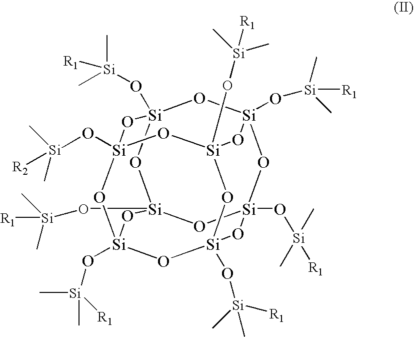

wherein R₁ and R₂ are independently selected lumophores with emission wavelengths that have CIE color coordinates that lie on a line that intersects the achromatic point.

These and other embodiments are described in greater detail below.

### BRIEF DESCRIPTION OF THE DRAWINGS

These and other aspects of the invention will be readily apparent from the following description and from the appended drawings, which are meant to illustrate and not to limit the invention, and wherein:

FIG. 1 illustrates a process for preparing white light-emitting compositions comprising a silsequioxane nanoparticle core.

FIG. 2 illustrates a synthetic method for preparing a blue lumophore.

FIG. 3 illustrates a synthetic method for preparing a intermediate compound 3-4 useful for making a red or orange lumophore.

FIG. 4 illustrates a synthetic method for preparing an orange lumophore.

FIG. 5 illustrates a synthetic method for preparing a light-emitting lumophore-functionalized nanoparticle.

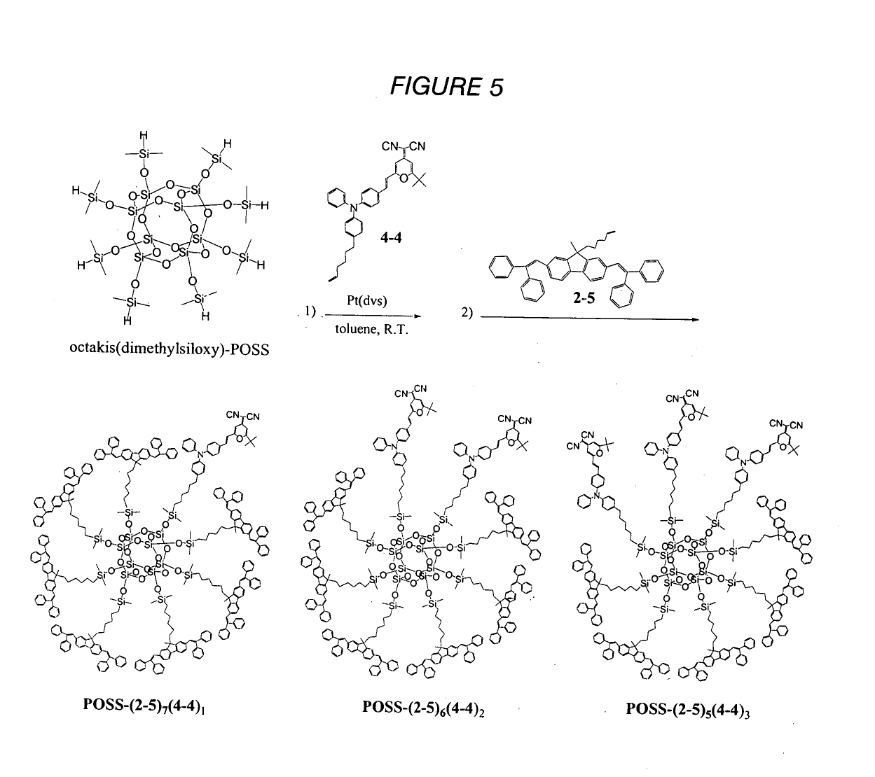

FIG. 6 illustrates a 2-dimensional CIE color coordinate diagram.

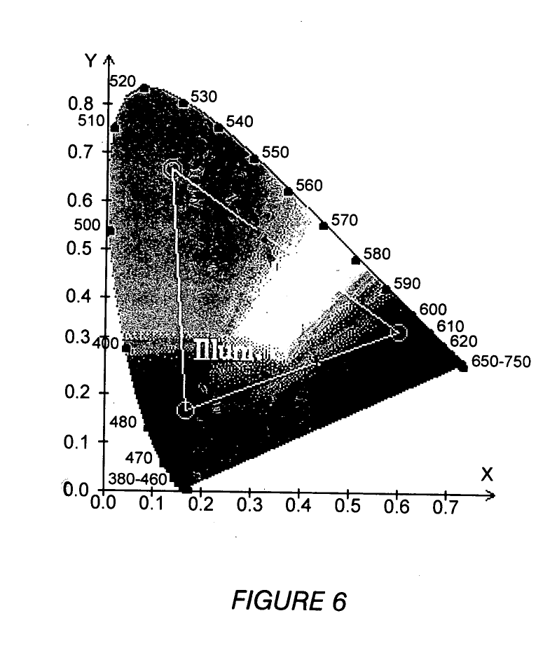

### DETAILED DESCRIPTION OF EMBODIMENTS

Definitions

A nanoparticle is a particle having a cross-sectional measurement (e.g., diameter if spherical) of about 100 nm or less. Dendrimers are examples of nanoparticles. Nanoparticles may be soluble or insoluble polymers (copolymers, hyperbranched polymers, etc), having the ability to aggregate, accumulate and/or self-assemble into particles of about 100 nm or less. The silsequioxane group of the formula (II) is an example of a nanoparticle.

Dendrimers are branched molecular materials that exhibit useful properties of both small molecules and polymers. See e.g. Fréchet, J. M. J.; Hawker, C. J. Comprehensive Polymer Science, 2nd Supplement; Pergamon: Oxford, England, 1996; pp 140-206. A dendrimer is a monodisperse synthetic macromolecule possessing a three-dimensional architecture that comprises a central core, highly branched but substantially regular iterative building units, and numerous peripheral ending groups. A more detailed description of these terms is found in G. Odian, Principles of Polymerization, John Wiley, New York, 2^{nd} Ed., 1981, pp. 177-179 and in W. R. Sorenson, F. Sweeney and T. W. Campbell, Preparative Methods of Polymer Chemistry, John Wiley, New York, 3rd ed., 2001, pp. 442-444, both of which are hereby incorporated by reference in their entireties. The numerous functional groups in the periphery of dendrimers are ideally suited for the incorporation of light-emitting lumophores, e.g., by covalent bonding. Modifications of peripheral functional groups in dendrimers to accommodate the attachment of lumophores can be carried out by general methods described in “Dendrimers III: Design Dimension Function”, Vögtle, F., Vol. Ed. Top. Curr. Chem. 2001, 212. Similar methods may also used to functionalize polymer nanoparticles.

A “chromophore” is a molecule or aggregate of molecules that can absorb electromagnetic radiation. An “excited state” is an electronic state of a molecule in which the electrons populate an energy state that is higher than another energy state for the molecule.

A “lumophore” is a chromophore that emits light when exposed to electromagnetic radiation. The “quantum yield” is the ratio of the number of emitted photons to the number of photons absorbed. A light-emitting group is a lumophore.

“Silsequioxane” is the general name for a family of polycyclic compounds consisting of silicon and oxygen. Silsequioxanes are also known as silasesquioxanes and polyhedral oligomeric silsesquioxanes.

A material is white light-emitting if it emits white light. White light is light having the approximate CIE color coordinates (X=1/3, Y=1/3). The CIE color coordinates (X=1/3, Y=1/3) is defined as the achromatic point. The X and Y color coordinates are weights applied to the CIE primaries to match a color. A more detailed description of these terms may be found in CIE 1971, International Commission on Illumination, Colorimetry: Official Recommendations of the International Commission on Illumination, Publication CIE No. 15 (E-1.3.1) 1971, Bureau Central de la CIE, Paris, 1971 and in F. W. Billmeyer, Jr., M. Saltzman, Principles of Color Technology, 2nd edition, John Wiley & Sons, Inc., New York, 1981, both of which are hereby incorporated by reference in their entireties.

Light-emitting lumophore-functionalized nanoparticles may be prepared by covalently attaching a lumophore to a nanoparticle core. Various colors may be created by attaching 2 or more lumophores to a nanoparticle core in varying ratios. A preferred nanoparticle is a silsequioxane as shown in formula (I), more preferably a 1,3,5,7,9,11,13,15-octakis(dimethylsilyloxy)pentacyclo-[9.5.1.1^{3,9}.1^{5,15}.1^{7,13}]octasiloxane as shown in formula (II). The covalent attachment of lumophores to the silsequioxane core is preferably carried out in the general manner described for the attachment of various groups to silsequioxane in PCT WO 02/05971, which is hereby incorporated by reference.

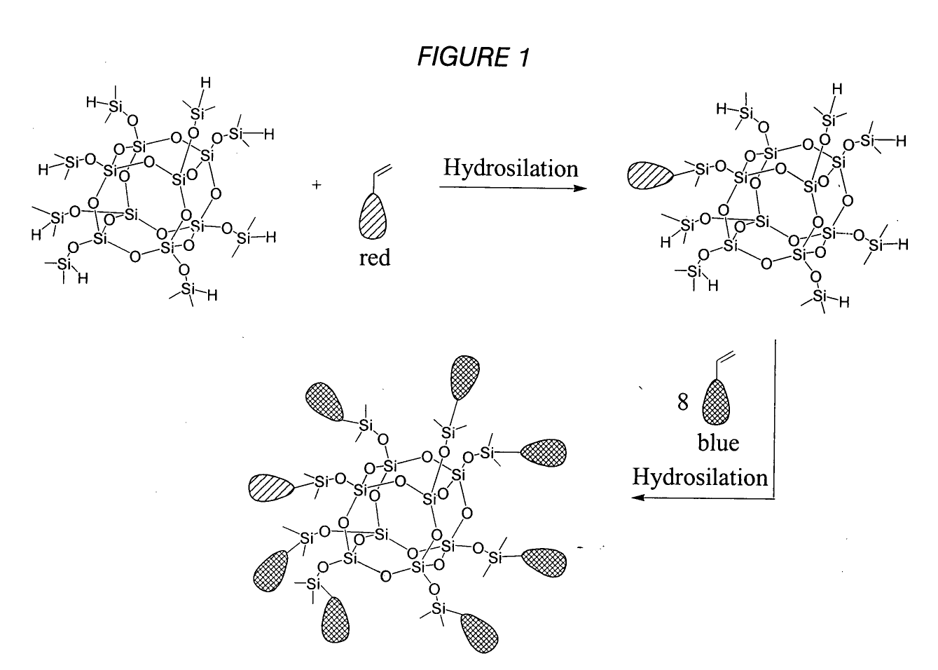

A preferred method for making nanoparticles that emit white light is illustrated in FIG. 1. For example, red and blue lumophores containing a primary alkene or other functional group may be attached to the nanoparticle core randomly from a mixture containing the functionalized lumophores in varying ratios. In an embodiment, the numbers of red and blue lumophores on each nanoparticle core are precisely controlled such that there are seven blue emitting lumophores and one red emitting lumophore. An example of a method for controlling the number of lumophores is as follows: A red lumophore comprising a primary alkene group is attached to a silsequioxane via hydrosilation under high dilution conditions using a platinum catalyst, e.g. hexachloroplatinic acid or Pt(dvs) (platinum-divinyl tetramethyldisiloxane complex). The silsequioxane starting material is present in molar excess, preferably greater than 1.1 fold molar excess, more preferably greater than 1.5 fold molar excess, most preferably greater than 2.0 fold molar excess. The resulting product is a silsequioxane having about seven unreacted functional groups, e.g. silane (Si—H), and about one covalently attached red light-emitting lumophore. A preferred product is depicted in formula III, where R represents the red light-emitting lumophore.

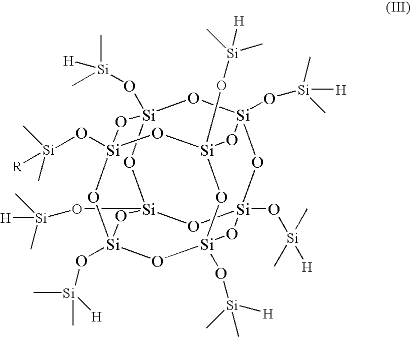

Preferred red light-emitting lumophores may be selected from the group consisting of pyrromethene lumophore, rhodamine lumophore, metalloporphyrin lumophore, metallophthalocyanine lumophore, pyran-4-ylidene-malononitrile lumophore and rubrene lumophore. Particularly preferred red light-emitting lumophores include rubrene lumophores and 2-{2-[2-(4-diphenylamino-phenyl)-vinyl]-6-methyl-pyran-4-ylidene}-malononitrile lumophores. The red light-emitting lumophore-functionalized silsequioxane (preferably comprising about 7 Si—H groups) of formula (III) is then separated from unreacted silsequioxane starting material via methods known to those skilled in the art.

A blue light-emitting lumophore is then attached to the red light-emitting lumophore-substituted silsequioxane of formula (III), preferably by the same general method as used for the attachment of the red light-emitting lumophore except that there is at least one molar equivalent of blue light-emitting lumophore per unreacted functional group on the red light-emitting lumophore substituted silsequioxane of formula (III). Preferred blue light-emitting lumophores may be selected from the group consisting of polyparaphenylene lumophore, fluorene lumophore, stilbene lumophore, biphenyl lumophore and polyaromatic hydrocarbon lumophore. A particularly preferred blue light-emitting lumophore is a 2,7-bis-(2,2-diphenyl-vinyl)-fluorene lumophore.

Other lumophore-functionalized silsequioxanes may be prepared in a similar manner by attaching various lumophores of various colors to the silsequioxane. For example, a silsequioxane may be functionalized with red, blue and green lumophores by using a reaction sequence similar to that described above, except that the molar ratios of the reactants are adjusted so that the silsequioxane contains unreacted functional groups after functionalization with the red and blue lumophores. These unreacted functional groups may then be reacted with green lumophores to provide a light-emitting lumophore-functionalized silsequioxane. Those skilled in the art will appreciate that the functionalization process described above may be modified by controlling the respective molar ratios and number of reaction stages to produce light-emitting lumophore-functionalized silsequioxanes having 1, 2, 3, 4, 5, 6, 7, or 8 different lumophores. Similarly, the functionalization process described above may be further modified (also by adjusting the respective molar ratios and number of reaction stages) to produce light-emitting lumophore-functionalized silsequioxane having various ratios of particular lumophores (e.g., 8 red; 8 blue; 8 green; 4 red and 4 blue; 4 blue and 4 green; 4 red and 4 green; 3 red, 3 blue and 2 green; 2 red, 3 blue and 3 green; 3 red, 2 blue and 3 green, etc.). The colors of the lumophores are not limited to red, green and blue, and thus the functionalization processes described above may be modified to utilize virtually any combination of lumophores, each having virtually any individual color, e.g., cyan, orange, red-orange, yellow, purple, magenta, etc. A wide variety of lumophores are commercially available and may be modified (if such modification is needed) to contain a functional group (such as a primary alkene group) capable of reacting with a functional group (such as silane) on the nanoparticle core. The process described above may also be modified to utilize other nanoparticles.

This invention is not bound by theory, but it is believed that the emission of white light by the functionalized nanoparticles described herein is improved by attaching the lumophores to the exterior surface of the nanoparticle, rather than embedding the lumophores in the nanoparticle matrix or core. The white light-emitting nanoparticles can be made to emit white light under conditions known to those skilled in the art such as, for example, irradiation with ultraviolet light, preferably light with a wavelength between about 250 nm and about 420 nm. Further the white light-emitting nanoparticles can be made to emit white light by inclusion into an OLED, using techniques known to those skilled in the art.

### EXAMPLES

General: In the following examples, all organic layers obtained after extractions were dried over MgSO₄. NMR spectra were recorded on a JOEL 400 MHz NMR spectrometer. All reactions were performed under Ar unless otherwise stated. Tetrahydrofuran (THF) and toluene were freshly distilled from Na/benzophenone prior to use. All other reagents were purchased from Aldrich and used without further purification.

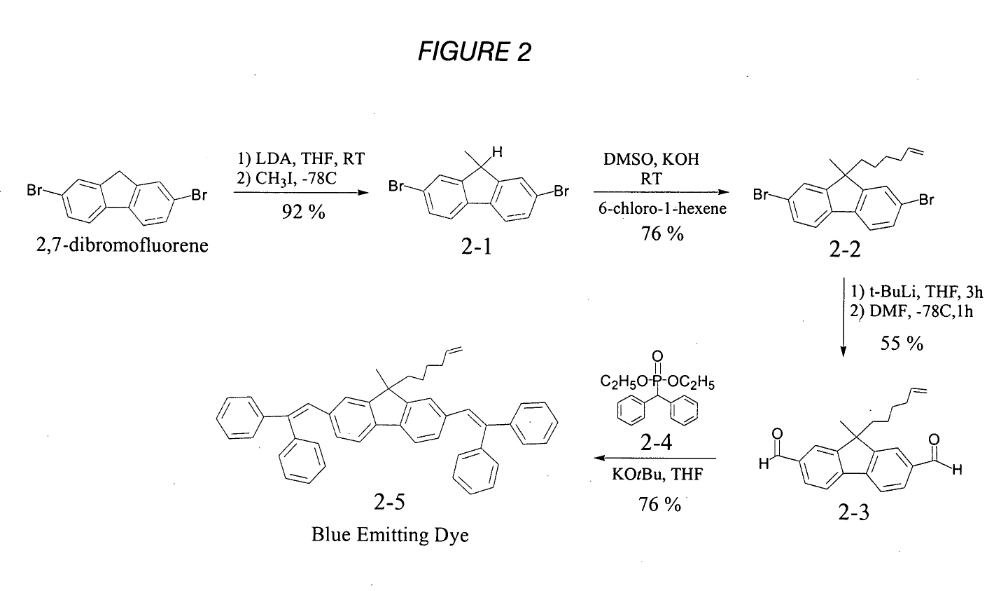

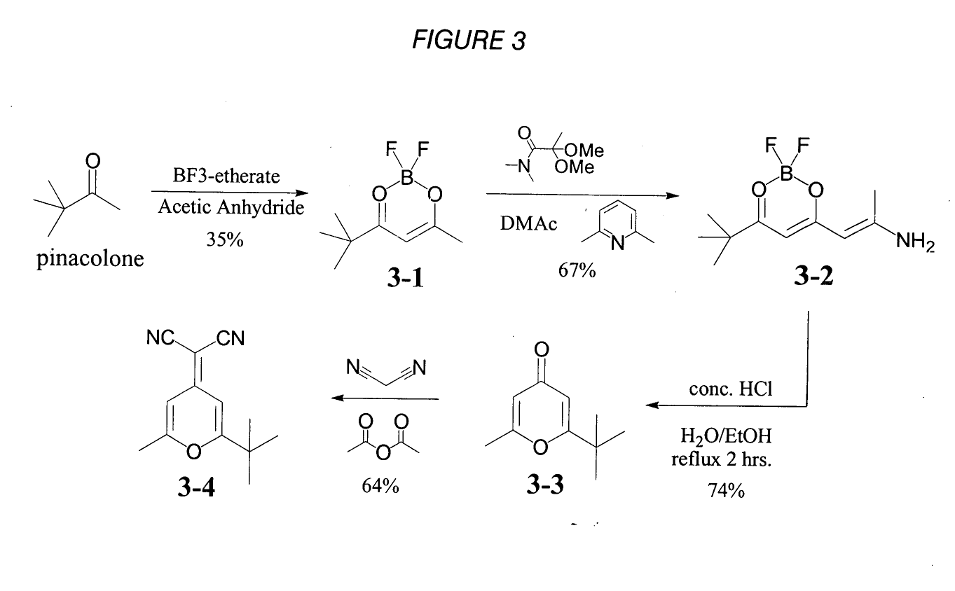

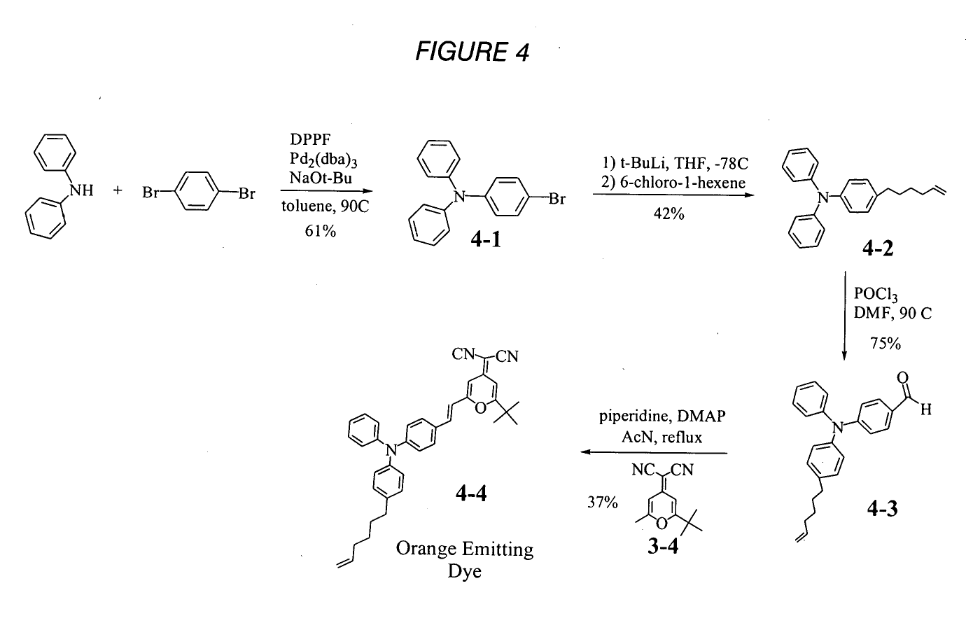

The blue lumophore 9-hexenyl-2,7-bis-(2,2-diphenyl-vinyl)-9-methyl-fluorene was prepared as illustrated in FIG. 2 and described in Examples 1-5 below. Other blue lumophores may be prepared similarly or by standard organic chemistry reactions and techniques. A red lumophore may also be prepared by standard organic chemistry reactions and techniques, e.g., in the manner illustrated in FIG. 3-4 and described in Examples 6-13 below. Other functionalized lumophores may be prepared similarly.

Red and blue lumophores may be attached to nanoparticles to prepare light-emitting lumophore-functionalized nanoparticles using standard organic chemistry reactions and techniques. Preferably, the lumophores are attached to a silsequioxane core in the general manner described for the attachment of various groups to silsequioxane in PCT WO 02/05971. An example of a method for attaching lumophores to a nanoparticle core is described below in Example 14. Light emission by the resulting light-emitting lumophore-functionalized nanoparticles may be measured by the use of an integrating sphere or other technique known to those skilled in the art. Descriptions of measurement of color are provide in R. W. G. Hunt, Measuring Colour, Ellis Horwood Ltd, 1987 and in Douglas A. Skoog, F. James Holler, Timothy A. Nieman, Principles of Instrumental Analysis; Saunders College Publishing, Philadelphia, 1998, Ch. 15, both of which are hereby incorporated by reference in their entireties.

### Example 1

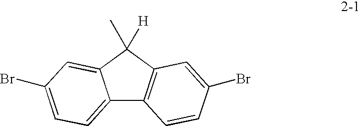

Synthesis of 2-1: A clean, dry round bottom flask was charged with a stirbar, 2,7-dibromofluorene (25.25 g, 77.93 mmol), and freshly distilled THF (250 mL). The flask was fitted with a septum and argon was bubbled through the solution for 15 minutes. While maintaining positive argon pressure, the reaction mixture was cooled to −78 C in a dry ice/acetone bath for 15 minutes. Lithium Diisopropyl Amide (LDA) (2.0 M in THF, 44.81 mL, 89.62 mmol) was added to the reaction mixture by syringe. The flask was then removed from the cold bath until it warmed to room temperature (RT) then it was placed in the −78 C bath again. Once the reaction mixture was cooled back down to −78 C, excess CH₃I (15 mL, 240 mmol) was added. The reaction mixture was stirred for 15 minutes then allowed to warm up to RT and remain at RT for 1 hour. The reaction mixture was then quenched by the addition of 2.5 mL acetic acid. After removing solvent by rotovap, the crude product was then purified by flash chromatography (SiO₂) using dichloromethane (DCM) as the elluent and recrystallized from hexanes to yield 24.21 g (92%) of the product as white needles.

### Example 2

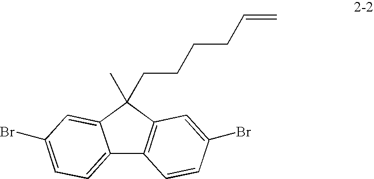

Synthesis of 2-2: A clean, dry round bottom flask was charged with product (2-1) (10.0 g, 29.59 mmol) and dry DMSO (100 mL). The solution was degassed by bubbling argon through it for 15 minutes. KOH (10 g, 177.5 mmol) and 6-chloro-1-hexene (23.4 mL, 177.5 mmol) were added to the flask and the reaction was stirred for 30 minutes at room temperature. The crude product was extracted with hexane/water and the hexane layer was washed with water 4×, collected and concentrated in vacuo. The residue was filtered through a silica plug using hexane as the elluent and the product was recrystallized from hexanes to yield 8.99 g (72%) off white solid.

### Example 3

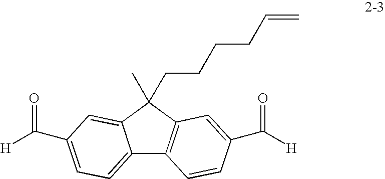

Synthesis of 2-3: A round bottom flask was charged with product (2-2) (8.38 g, 19.95 mmol) and dry THF (100 mL). The solution was degassed by bubbling argon through it for 15 minutes. The reaction mixture was cooled to −78 C in a dry ice/acetone bath. Tert-butyllithium (1.7 M in pentane, 46.9 mL, 79.80 mmol) was added drop wise to reaction flask. The flask was stirred at −78 C for 30 minutes and then allowed to warm up to room temperature for 3 hours. The flask was then cooled back down to −78 C and dry DMF (12.3 mL, 159.62 mmol) was added. The flask was then allowed to warm up to room temperature for 1 hour. The reaction mixture was then poured into water and extracted with EtOAc. The EtOAc layer was washed 5× with acidic water. The EtOAc was evaporated in vacuo and the residue was chromatographed with 3:2 DCM:hexane to yield 3.50 g (55%) of the product as a yellow oil.

### Example 4

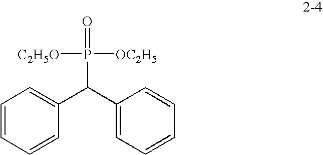

Synthesis of 2-4: A round bottom flask was charged with chlorodiphenylmethane (15 g, 13.2 mL, 74.0 mmol) and triethyl phosphite (98.4 g, 103 mL 592 mmol) and refluxed overnight. The excess P(OEt)₃ and ethyl chloride (byproducts) were removed by distillation. The reaction mixture was then further purified by chromatography using 1:1 DCM:Hexanes to elude the chlorodiphenyl methane and 1:9 acetone:DCM to elude the product as a clear oil. The product was then recrystallized from hexanes to yield 8.32 g (37%) white needles.

### Example 5

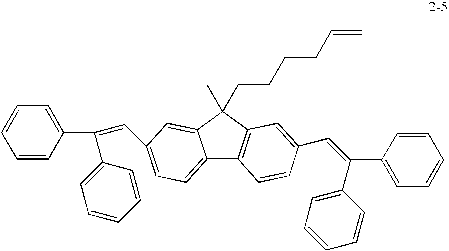

Synthesis of 2-5: A dry, round bottom flask was charged with benzhydryl-phosphonic acid diethyl ester (2-4) (7.86 g, 25.87 mmol), potassium tert-butoxide (3.48 g 31.04 mmol) and dry THF (50 mL). The solution was degassed by bubbling argon through it for 15 minutes. Meanwhile 9-(5-hexenyl)-9-methyl-2,7-formylfluorene (2-3) (3.29 g, 10.35 mmol) was added to another round bottom flask, dissolved in 50 ml dry THF and the solution was degassed with argon for 15 min. The solution containing (2-3) was then cannulated into the round bottom flask containing (24) and potassium tert-butoxide. The final solution was allowed to stir at room temperature for 3 hours. The THF was then evaporated in vacuo and the residue was dissolved in EtOAc. The EtOAc layer was washed with water 4× and brine and dried over MgSO4. After flash chromatography (SiO2) using 1:4 DCM:Hexane, the collected product was then recrystallized from EtOH to yield 4.86 g (76%) of the product as a yellow micro crystal.

### Example 6

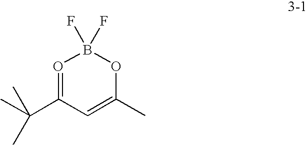

Synthesis of 3-1: To a solution of pinacolone (69.0 ml, 555 mmol) in BF3-diethyl etherate (0.95 eq., 74.8 g, 66.8 mL) that is cooled to 0° C., acetic anhydride (2 eq., 113.3 g, 104 ml) was added dropwise over the course of 30 min. The reaction was stirred overnight at RT, and then vacuum distilled at 90-95° C. Then, 3×2 L of hexane was added to the resulting tar and heated to a boil and decanted. The combined hexane extractions were condensed, which after plug filtration, was crystallized from hexane to yield 35.1 g (35%) of light yellow crystals as product.

### Example 7

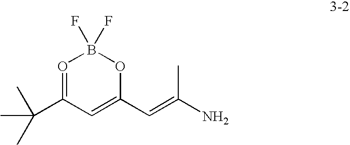

Synthesis of 3-2: A solution of 3-1 (35.1 g, 185 mmol), 2,6-leutidine (0.076 eq., 1.51 g), in N,N-dimethylacetamide (35 ml) was heated to 60° C. Dimethylacetamide dimethyl acetal (1.48 eq., 40 ml) was then added dropwise. After stirring the solution at 85° C. for 3 hours, it was cooled to RT, and then it was placed in dry-ice for 5 min to facilitate crystallization. Orange crystals were collected, and recrystallized from acetone to yield 28.45 g (67%) of product as a pastel orange solid.

### Example 8

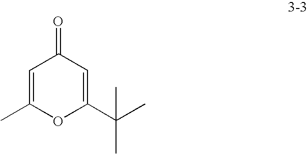

Synthesis of 3-3: To a solution of 3-2 (28.45 g, 123 mmol) in ethanol (525 ml) and water (50 ml), conc. HCl (34.6 ml, 346 mmol) was added dropwise at RT. Then, the solution was stirred at 90° C. for 3 hours. The solvent was evaporated and made alkaline by adding water followed by ammonium hydroxide, and then the product was extracted into ether. After evaporation, the product was then crystallized from hexane to yield 15.08 g (74%) of a yellow translucent solid.

### Example 9

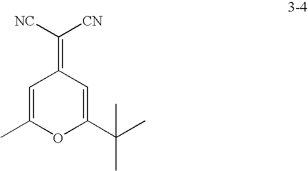

Synthesis of 3-4: A solution of 3-3 (15.08 g, 90.7 mmol), malononitrile (7.26 g, 110 mmol), in acetic anhydride (38.2 ml) was stirred at 120° C. for 6 hours. Then the excess acetic anhydride/acid was vacuum distilled off until the reaction flask was nearly dry. Ethanol was added to the sludgy reaction mixture and heated to a boil. After cooling, the crude product precipitates. The product was filtered, and recrystallized from ethanol to yield 12.37 g (64%) of a peachy fibrous solid.

### Example 10

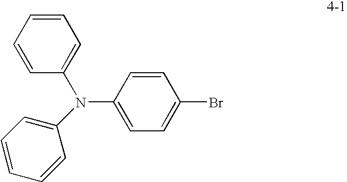

Synthesis of 4-1: A clean, dry round bottom flask was charged with a stirbar, diphenylamine (10.0 g, 59.2 mmol), 1,4-dibromobenzene (20g, 84.7 mmol), and dry toluene (300 mL). The solution was degassed for 10 minutes by argon followed by the addition of Pd₂(dba)₃ (tris(dibenzylideneacetone)dipalladium) (405 mg, 0.443 mmol), DPPF (1,1′-bis(diphenylphosphino) ferrocene) (735 mg, 1.33 mmol) and sodium tert-butoxide (17.0 g, 177 mmol). The reaction mixture was then stirred at 90° C. overnight under positive argon pressure. The reaction mixture was then filtered and the toluene was evaporated in vacuo. The product was chromatographed using hexanes and dried to yield 11.67 g (61%) white, microcrystal.

### Example 11

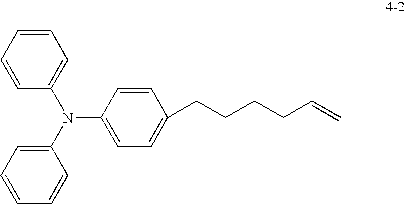

Synthesis of 4-2: A clean, dry round bottom flask was charged with a stirbar, (4-1) (10.0 g, 30.9 mmol) and freshly distilled THF (100 ml). The solution was degassed for 15 minutes with argon and then cooled to −78 C in a dry ice/acetone bath under positive argon pressure. Tert-butyllithium (36.3 ml, 1.70M solution in pentane, 61.7 mmol) was added via syringe and the reaction mixture was stirred at −78 C for 30 minutes. 6-chloro-1-hexene was then added and the reaction mixture was stirred at −78 C for 15 minutes and then allowed to warm up to room temperature. The reaction mixture was then heated to 50 C overnight. The THF was evaporated in vacuo and the residue dissolved in EtOAc and washed with water. The product was chromoatographed using hexanes to yield 4.22 g (42%) clear oil.

### Example 12

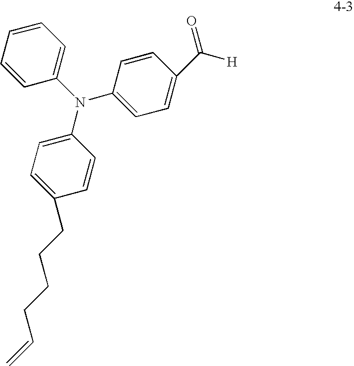

Synthesis of 4-3: A clean, dry round bottom flask was charged with a stirbar, (4-2) (1.05 g, 3.21 mmol) and DMF (7.5 ml, 103 mmol). POCl₃ (0.45 ml, 4.82 mmol) was added and the reaction mixture was stirred at 90 C for 3 hours. The reaction mixture was poured into water and product was extracted into EtOAc. The EtOAc layer was rinsed with water 2× and evaporated in vacuo. The product was then chromatographed using 3:2 DCM:hexanes to yield 860 mg (75%) yellow oil.

### Example 13

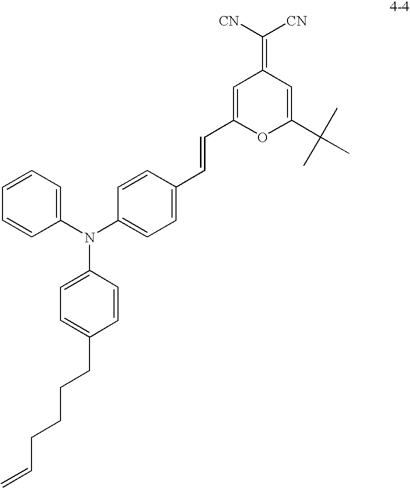

Synthesis of 4-4: A clean, dry round bottom flask was charged with a stirbar, (4-3) (860 mg, 2.42 mmol), (3-4) (518 mg, 2.42 mmol), 4-(dimethylamino)-pyridine (DMAP) (59 mg, 0.49 mmol), piperidine (0.5 ml, 4.9 mmol) and dry acetonitrile (25 ml). The solution was refluxed overnight. The acetonitrile was evaporated in vacuo and the product was chromatographed in 1:9 EtOAc:hexanes and recrystalized from MeOH to yield 496 mg (37%) dark red needle like crystals.

### Example 14

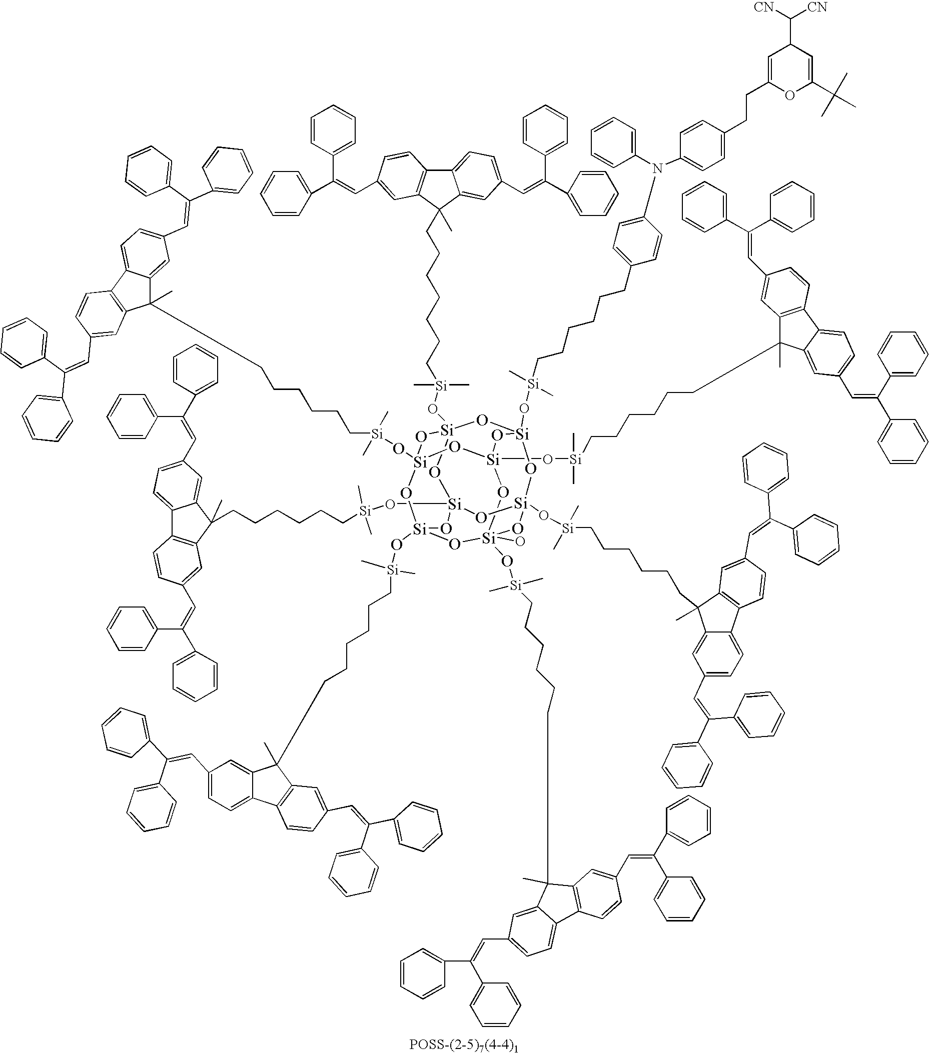

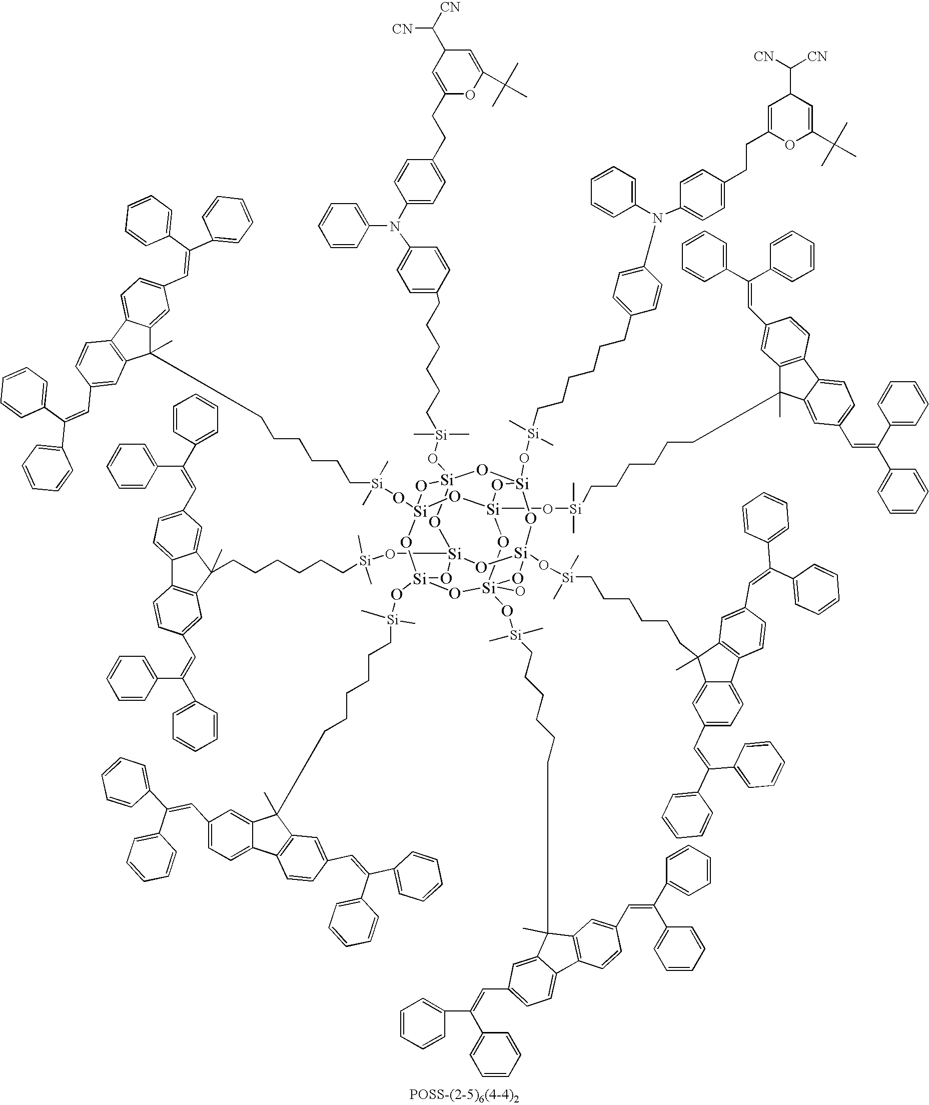

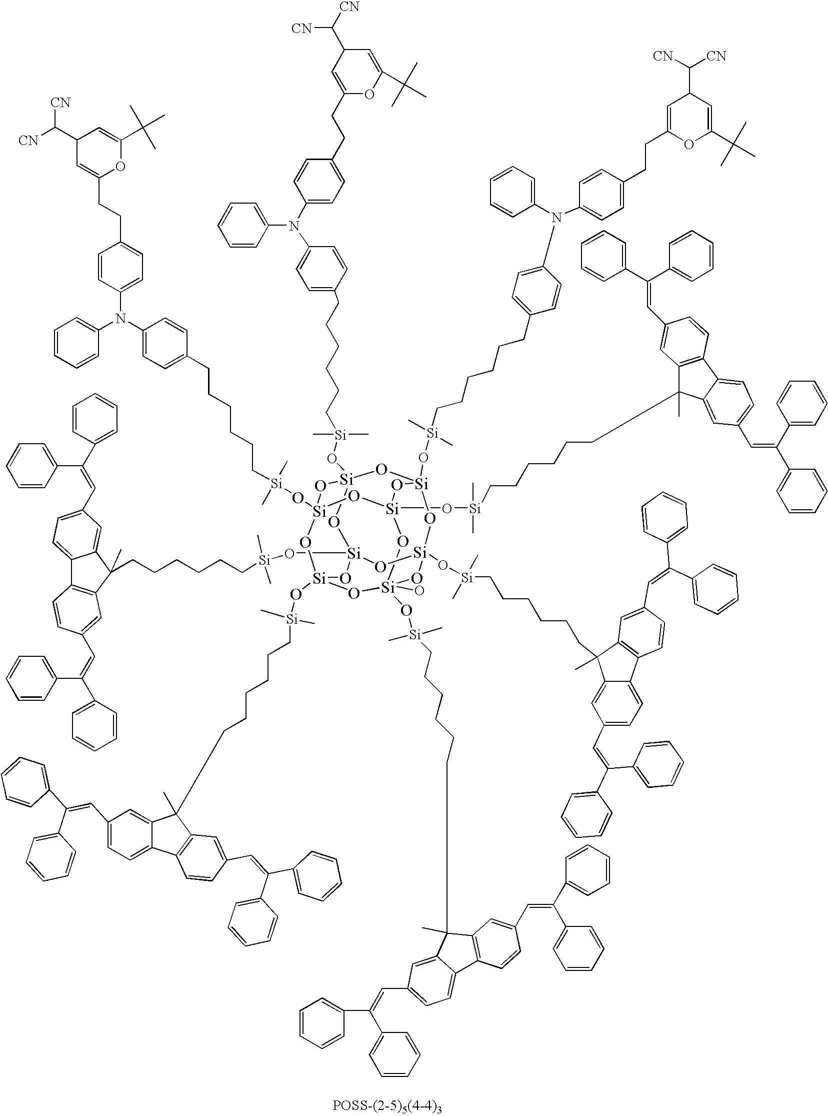

Synthesis of POSS-(2-5)7(4-4)1, POSS-(2-5)6(4-4)2, and POSS-(2-5)5(4-4)3: A clean, dry round bottom flask was charged with a stirbar, 1,3,5,7,9,11,13,15-octakis(dimethylsilyloxy)pentacyclo-[9.5.1.1^{3,9}.1^{5,15}.1^{7,13}]-octasiloxane (octakis(dimethylsiloxy)-POSS) (340 mg, 0.334 mmol), (4-4) (369 mg, 0.669 mmol), and dry toluene (5 ml). Pt(dvs) (platinum-divinyl tetramethyldisiloxane complex) (0.05 ml, 2% Pt wt. solution in xylene) was added and the reaction mixture was stirred at room temperature under positive argon pressure for 30 minutes. A solution of (2-5) (1.65 g, 2.67 mmol) in toluene (15 ml), and 0.05 ml of additional Pt(dvs) solution were added and the reaction mixture was allowed to stir at room temperature for 2 hours. The toluene was evaporated in vacuo and POSS-(2-5)7(4-4)1 was separated chromatographically using 3:2 DCM:hexanes to yield 348 mg (18%). POSS-(2-5)6(4-4)2 and POSS-(2-5)5(4-4)3 were then separated using DCM to yield 475 mg (24%) and 177 mg (9%), respectively.

It will be appreciated by those skilled in the art that various omissions, additions and modifications may be made to the processes described above without departing from the scope of the invention, and all such modifications and changes are intended to fall within the scope of the invention

1. A light-emitting lumophore-functionalized nanoparticle.

2. The light-emitting lumophore-functionalized nanoparticle of claim 1 that is capable of emitting white light.

3. A light-emitting composition comprising:
a nanoparticle core; and
two or more lumophores attached to the nanoparticle core.

4. The light-emitting composition of claim 3 that is capable of emitting white light.

5. The light-emitting composition of claim 3 in which the nanoparticle core comprises a silsequioxane.

6. The light-emitting composition of claim 5 in which the silsequioxane comprises a 1,3,5,7,9,11,13,15-octakis(dimethylsilyloxy)pentacyclo-[9.5.1.1^{3,9}.1^{5,15}.1^{7,13}]-octasiloxane.

7. The light-emitting composition of claim 3 in which the two or more lumophores comprise a red light-emitting lumophore and a blue light-emitting lumophore

8. The light-emitting composition of claim 7 in which the red light-emitting lumophore is capable of emitting light having a wavelength in the range of about 560 nm to about 750 nm.

9. The light-emitting composition of claim 7 in which the blue light-emitting lumophore is capable of emitting light having a wavelength in the range of about 400 nm to about 480 nm.

10. The light-emitting composition of claim 7 in which the blue light-emitting lumophore is selected from the group consisting of polyparaphenylene lumophore, fluorene lumophore, stilbene lumophore, biphenyl lumophore and polyaromatic hydrocarbon lumophore.

11. The light-emitting composition of claim 10 in which the blue light-emitting lumophore is a 2,7-bis-(2,2-diphenyl-vinyl)-fluorene lumophore

12. The light-emitting composition of claim 7 in which the red light-emitting lumophore is selected from the group consisting of pyrromethene lumophore, rhodamine lumophore, metalloporphyrin lumophore, metallophthalocyanine lumophore, pyran-4-ylidene-malononitrile lumophore and rubrene lumophore.

13. The light-emitting composition of claim 12 in which the red light-emitting lumophore is a rubrene lumophore.

14. The light-emitting composition of claim 12 in which the red light-emitting lumophore is a 2-[2-tert-butyl-6-(2-{4-[(4-hexyl-phenyl)-phenyl-amino]-phenyl}-vinyl)-pyran-4-ylidene]-malononitrile lumophore.

15. The light-emitting composition of claim 5 comprising:
about seven blue lumophores; and
about 1 red lumophore.

16. The light-emitting composition of claim 15 in which the blue light-emitting lumophore is selected from the group consisting of polyparaphenylene lumophore, fluorene lumophore, stilbene lumophore, biphenyl lumophore and polyaromatic hydrocarbon lumophore.

17. The light-emitting composition of claim 16 in which the blue light-emitting lumophore is a 2,7-bis-(2,2-diphenyl-vinyl)-fluorene lumophore.

18. The light-emitting composition of claim 15 in which the red light-emitting lumophore is selected from the group consisting of pyrromethene lumophore, rhodamine lumophore, metalloporphyrin lumophore, metallophthalocyanine lumophore, pyran-4-ylidene-malononitrile lumophore and rubrene lumophore.

19. The light-emitting composition of claim 18 in which the red light-emitting lumophore is a rubrene.

20. The light-emitting composition of claim 18 in which the red light-emitting lumophore is a 2-[2-tert-butyl-6-(2-{4-[(4-hexyl-phenyl)-phenyl-amino]-phenyl}-vinyl)-pyran-4-ylidene]-malononitrile lumophore.
